(19) United States
(12) Patent Application Publication
(10) Pub. No.: US 2025/0371582 A1
(43) Pub. Date: Dec. 4, 2025

(54) METHOD AND SERVER FOR GENERATING AND SENDING ADVERTISEMENT

(71) Applicant: Chih-Chang LIN, Taichung City (TW)

(72) Inventor: Chih-Chang LIN, Taichung City (TW)

(21) Appl. No.: 19/216,638

(22) Filed: May 22, 2025

(30) Foreign Application Priority Data
May 31, 2024 (TW) 113120209

(51) Int. Cl. G06Q 30/0251; G06Q 30/0241

(52) U.S. Cl. CPC G06Q 30/0269; G06Q 30/0276

(57) ABSTRACT

A method for generating and sending an advertisement is implemented by a server that communicates with an initiating device operated by an initiating user and with at least one online platform, each online platform communicating with multiple promotion-end devices. The method includes: obtaining multiple sets of promotional information related to an object, and transmitting the same to the initiating device for the initiating device to obtain and transmit to the server a set of basic promotional information; obtaining a target user account, and a target platform based on the target user account; generating a set of target promotional information; making the target user account serve as a promotion user account, and transmitting the set of target promotional information and the promotion user account to the target platform for the target platform to transmit the set of target promotional information to a target promotion-end device corresponding to the promotion user account.

### CROSS-REFERENCE TO RELATED APPLICATION

This application claims priority to Taiwanese Invention patent application No. 113120209, filed on May 31, 2024, the entire disclosure of which is incorporated by reference herein.

### FIELD

The disclosure relates to a method and a server for generating and sending an advertisement, and more particularly to a method and a server for automatically generating an advertisement and sending the same to a selected recipient.

### BACKGROUND

At present, most advertisements placed on various online platforms are first produced by brands, advertisers or individuals for products they wish to promote. Then, big data analytics is used to obtain users related to the products being promoted, and the advertisements are sent to the relevant users. However, producing advertisement products and ideas requires brands, advertisers and individuals to invest relatively large amounts of money in advertisement production.

### SUMMARY

Therefore, an object of the disclosure is to provide a method and a server for automatically generating an advertisement and sending the advertisement to one or more selected recipients that can alleviate at least one of the drawbacks of the prior art.

According to an aspect of the disclosure, a method for generating and sending an advertisement is to be implemented by a server that communicates with an initiating device operated by an initiating user and with at least one online platform. Each one of the at least one online platform communicates with multiple promotion-end devices. The server stores multiple user social datasets that are related respectively to multiple users including the initiating user. Each one of the user social datasets includes at least one associated users list respectively corresponding to the at least one online platform. Each one of the at least one associated users list includes multiple associated user accounts of multiple associated users that are associated with a corresponding one of the users. The method includes steps of: based on a set of input information from the initiating device and related to an object, obtaining, by utilizing a promotional information recommendation model, multiple sets of promotional information that are related to the object, and transmitting the sets of promotional information to the initiating device for the initiating device to obtain a set of basic promotional information from among the sets of promotional information and to transmit the set of basic promotional information to the server; in response to receipt of a recipient confirmation command from the initiating device, obtaining at least one target user account from among the associated user accounts in one of the user social datasets corresponding to the initiating user, and obtaining at least one target platform based on the at least one target user account; based on the set of basic promotional information and a set of adjustment information used for adjusting the set of basic promotional information, generating a set of target promotional information by utilizing an advertisement generation model; and, for each target platform of the at least one target platform, making the at least one target user account corresponding to the target platform serve as at least one promotion user account, and transmitting the set of target promotional information and the at least one promotion user account to the target platform for the target platform to transmit the set of target promotional information to at least one target promotion-end device that corresponds to the at least one promotion user account, where each one of the at least one target promotion-end device is one of the promotion-end devices.

According to another aspect of the disclosure, a server for generating and sending an advertisement includes a server communication module, a server storage module and a server processing module. The server communication module is configured to communicate with an initiating device operated by an initiating user, and with at least one online platform. Each one of the at least one online platform communicates with multiple promotion-end devices. The server storage module is configured to store multiple user social datasets that are related respectively to multiple users including the initiating user. Each one of the user social datasets includes at least one associated users list respectively corresponding to the at least one online platform. Each one of the associated users list includes multiple associated user accounts of multiple associates users that are associated with a corresponding one of the users. The server processing module is configured to be electrically connected to the server communication module and to the server storage module.

The server processing module is further configured to: in response to receiving through the server communication module a set of input information from the initiating device and related to an object, obtain, by utilizing a promotional information recommendation model, multiple sets of promotional information that are related to the object, and transmit the sets of promotional information to the initiating device through the server communication module for the initiating device to obtain a set of basic promotional information from among the sets of promotional information and to transmit the set of basic promotional information to the server; in response to receiving through the server communication module a recipient confirmation command from the initiating device, obtain at least one target user account from among the associated user accounts in one of the user social datasets corresponding to the initiating user, and obtain at least one target platform based on the at least one target user account; based on the set of basic promotional information and a set of adjustment information used for adjusting the set of basic promotional information, generate a set of target promotional information by utilizing an advertisement generation model; and, for each target platform of the at least one target platform, make the at least one target user account corresponding to the target platform serve as at least one promotion user account, and transmit through the server communication module the set of target promotional information and the at least one promotion user account to the target platform for the target platform to transmit the set of target promotional information to at least one target promotion-end device that corresponds to the at least one promotion user account, where each one of the at least one target promotion-end device is one of the promotion-end devices.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a system for generating and sending an advertisement according to an embodiment of the disclosure.

FIGS. 2 to 4 cooperatively illustrate a flow chart of a method for generating and sending an advertisement according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

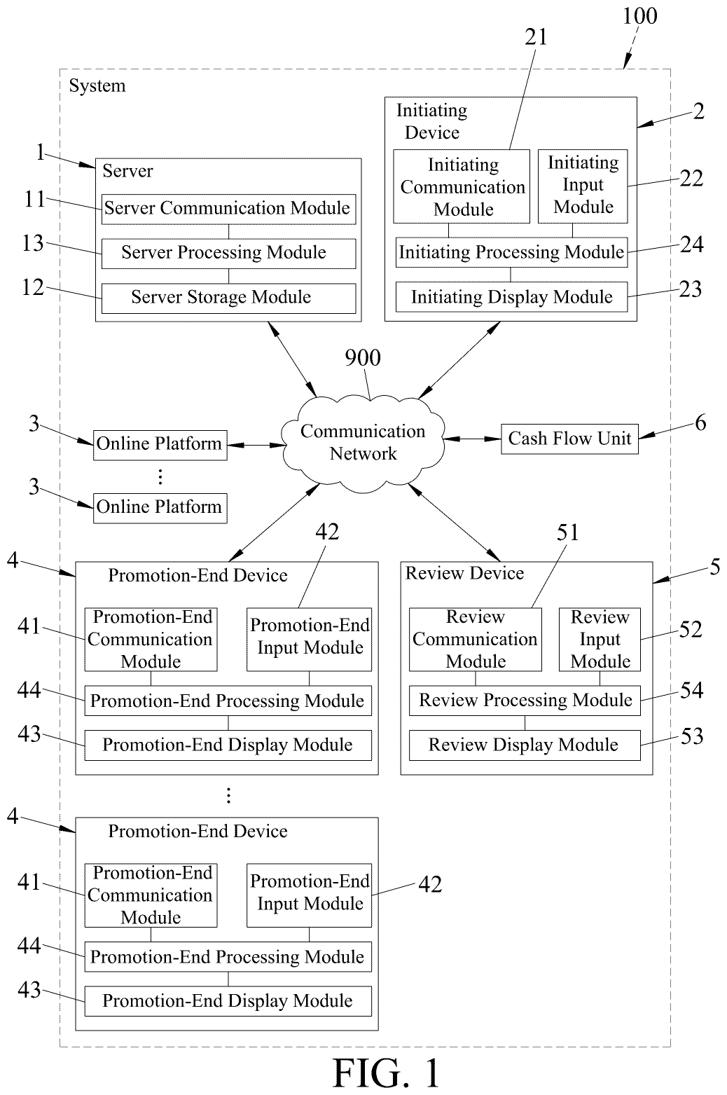

Referring to FIG. 1, an embodiment of a method for generating and sending an advertisement is implemented by a system 100 for generating and sending an advertisement. The system 100 includes a server 1 (a server for generating and sending an advertisement), an initiating device 2 that communicates with the server 1 through a communication network 900, multiple online platforms 3 that communicate with the server 1 through the communication network 900, multiple promotion-end devices 4 that communicate with the online platforms 3 through the communication network 900, a review device 5 that communicates with the server 1 through the communication network 900, and a cash flow unit 6 that communicates with the server 1 and with the initiating device 2 through the communication network 900.

The server 1 includes a server communication module 11, a server storage module 12, and a server processing module 13 electrically connected to the server communication module 11 and the server storage module 12.

The server storage module 12 stores multiple user social datasets that correspond respectively to multiple users. Each user social dataset includes one or more associated users lists of a user (also referred to as “corresponding user”) corresponding to the user social dataset. The associated users lists respectively correspond to the online platforms 3. Each associated users list includes multiple associated user accounts of multiple associated users that are associated with the corresponding user, and an internet usage record of each associated user. It is worth mentioning that the associated users on each associated users list include, but are not limited to, friends of the corresponding user on the corresponding online platform 3, the corresponding user's followers on the corresponding online platform 3, and users who have been in contact with the corresponding user on the corresponding online platform 3. In addition, each internet usage record includes, but is not limited to, a browsing history, cookies, or a combination thereof.

The initiating device 2 belongs to one of the users (hereinafter referred to as “the initiating user”). The initiating device 2 includes an initiating communication module 21, an initiating input module 22, an initiating display module 23, and an initiating processing unit 24 that is electrically connected to the initiating communication module 21, the initiating input module 22 and the initiating display module 23.

Each promotion-end device 4 belongs to a user who registers a user account on one of the online platforms 3, and includes a promotion-end communication module 41, a promotion-end input module 42, a promotion-end display module 43, and a promotion-end processing module 44 that is electrically connected to the promotion-end communication module 41, the promotion-end input module 42 and the promotion-end display module 43.

The review device 5 is to be operated by a reviewer, and includes a review communication module 51, a review input module 52, a review display module 53, and a review processing module 54 that is electrically connected to the review communication module 51, the review input module 52 and the review display module 53.

The cash flow unit 6 stores an initiating user money account of the initiating user, and a server money account of the server 1.

The communication network 900 may be, for example, the Internet.

The server 1 may be embodied as a server system or a personal computer, but is not limited thereto.

The server communication module 11 may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like.

The server storage module 12 may be embodied using, for example, one or more of a magnetic storage medium (e.g., hard disk drives, floppy disks, tape, etc.), an optical storage (CD-ROMs, DVDs, optical disks, etc.), a solid state device (SSD), a random access memory (RAM), read-only memory (ROM), programmable ROM (PROM), firmware, flash memory, etc.

The server processing module 13 may be embodied using, for example, one or more of a central processing unit (CPU), a microprocessor, a microcontroller, a single core processor, a multi-core processor, a dual-core mobile processor, a digital signal processor (DSP), a field-programmable gate array (FPGA), an application-specific integrated circuit (ASIC), a radio-frequency integrated circuit (RFIC), etc.

The initiating device 2 may be, for example, a tablet, a laptop, a smartphone or a personal computer, etc.

Each online platform 3 may be, for example, Facebook, Instagram, YouTube, TikTok, LinkedIn, X (formerly Twitter), Spotify, Apple Music, or any website, etc.

Each promotion-end device 4 may be, for example, a tablet, a laptop, a smartphone or a personal computer, etc.

The review device 5 may be, for example, a tablet, a laptop, a smartphone or a personal computer, etc.

Each of the initiating communication module 21 of the initiating device 2, the promotion-end communication module 41 of each promotion-end device 4, and the review communication module 51 of the review device 5 may use, for example, components that are similar to the server communication module 11 of the server 1.

Each of the initiating processing module 24 of the initiating device 2, the promotion-end processing module 44 of each promotion-end device 4, and the review processing module 54 of the review device 5 may use, for example, components that are similar to the server processing module 13 of the server 1.

Each of the initiating input module 22 of the initiating device 2, the promotion-end input module 42 of each promotion-end device 4, and the review input module 52 of the review device 5 may be, for example, a touch screen of a tablet or smartphone, or a keyboard of a laptop or personal computer, etc.

Each of the initiating display module 23 of the initiating device 2, the promotion-end display module 43 of each promotion-end device 4, and the review display module 53 of the review device 5 may be, for example, the display screen of a tablet or smartphone, or a monitor of a laptop or personal computer, etc.

The cash flow unit 6 may be, for example, a conventional bank account management system or a convention third-party payment platform, etc.

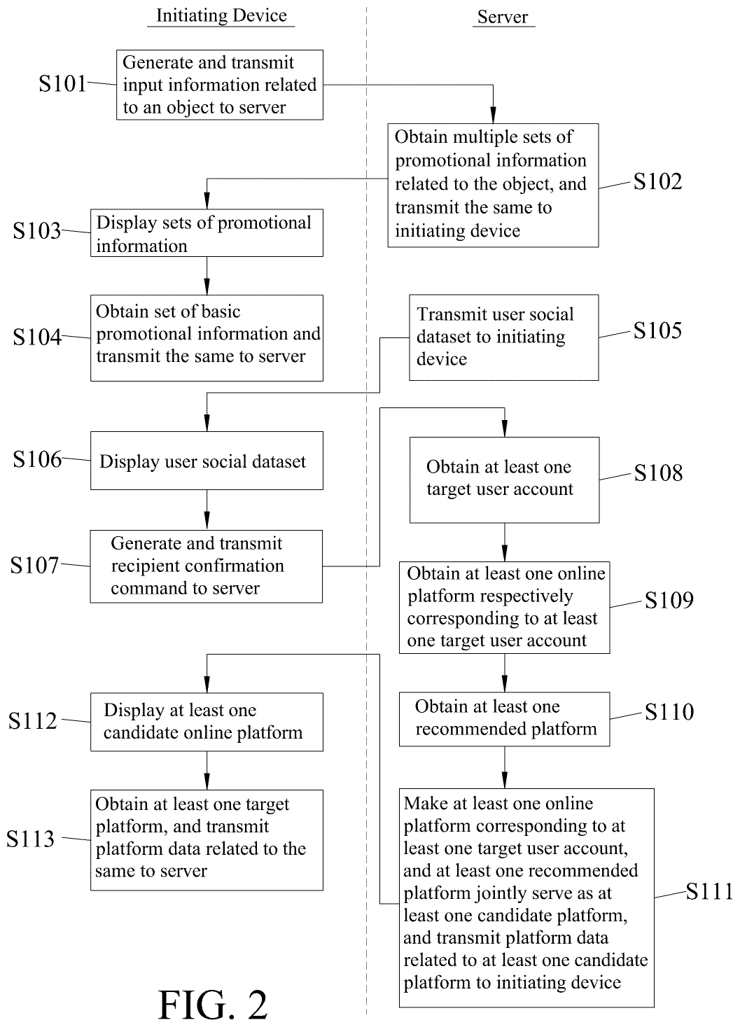

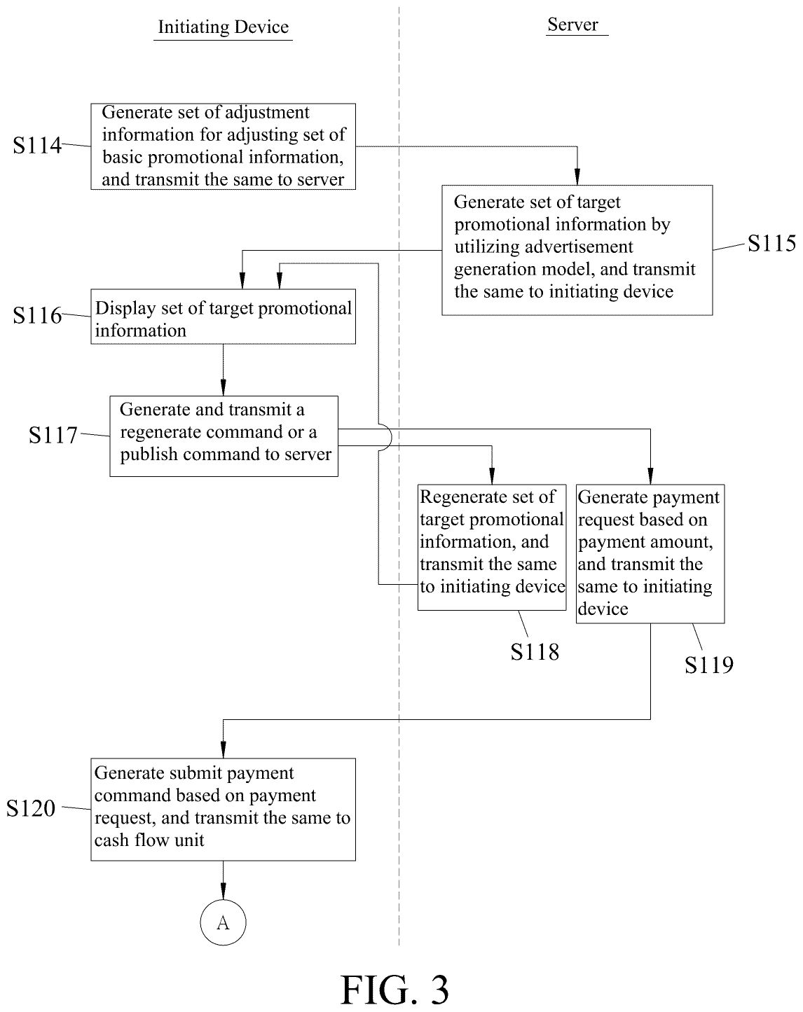

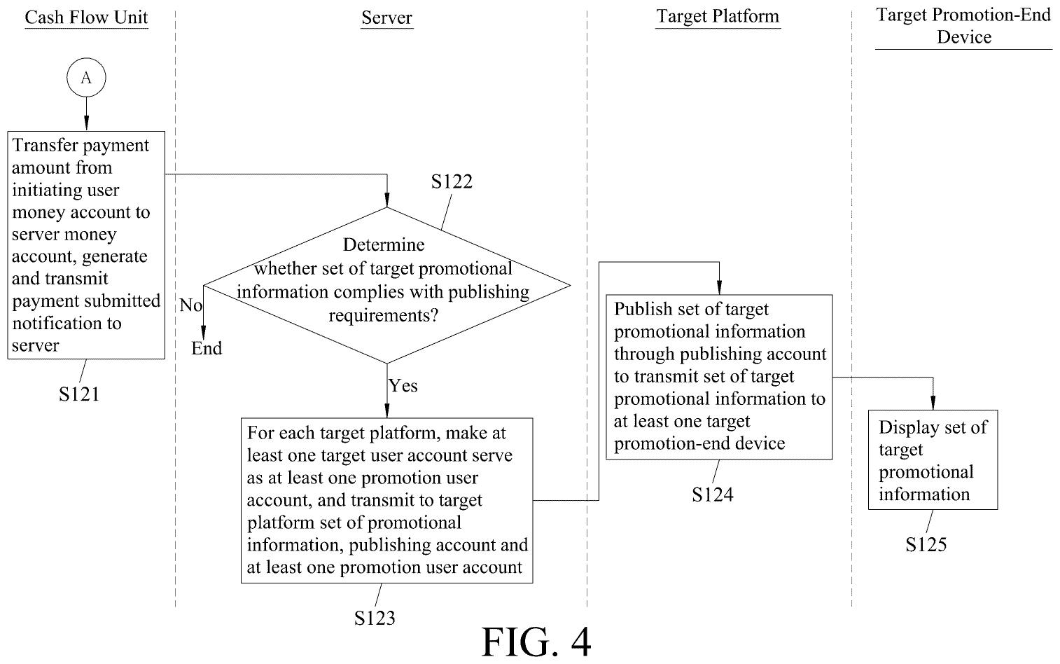

Referring to FIGS. 2 to 4, operation details of each component in the system 100 will be described below in conjunction with an embodiment of the method for generating and sending an advertisement of the disclosure. The method includes steps S101-S125.

In step S101, in response to user input generated by the initiating input module 22 through operation by the initiating user (e.g., the initiating user operating the initiating input module 22 to input some information), the initiating processing module 24 generates a set of input information related to an object based on the user input thus received, and transmits the set of input information to the server 1 through the initiating communication module 21. It is worth mentioning that in this embodiment, the set of input information is natural language inputted by the initiating user, but the disclosure is not limited thereto. For example, the set of input information may be, but is not limited to, “I want an iPhone for my birthday” or “I want to promote ‘60% of Women Want to Develop Exercise Habits.’” In addition, the object may be, but is not limited to, a physical item or an abstract concept, such as a physical product or an idea that the initiating user wishes to promote, or an item that the initiating user needs.

In step S102, after receiving the set of input information from the initiating device 2 through the server communication module 11, the server processing module 13, based on the set of input information, obtains multiple sets of promotional information related to the object by utilizing a promotional information recommendation model, and transmits the sets of promotional information to the initiating device 2 through the server communication module 11. It should be further noted that the sets of promotional information include, but are not limited to, a set of introductory information about the object, a report about the object, a video on any one of the online platforms 3 about the object, or combinations thereof. Using the above-mentioned example where the set of input information is “I want an iPhone for my birthday,” after analysis of the set of input information using the promotional information recommendation model, the object may be “iPhones,” and the sets of promotional information may be an introduction, a report or a short video of “iPhones”; using another example where the set of input information is “I want to promote ‘60% of Women Want to Develop Exercise Habits,’” after analysis of the set of input information using the promotional information recommendation model, the object may be “exercise habits,” and the sets of promotional information may be an introduction, a report or a short video of “exercise habits,” but the disclosure is not limited to these examples.

It is worth mentioning that in this embodiment, the promotional information recommendation model includes a large language model (LLM) that collects not only information published by various brands and by the online platform(s) 3 on the Internet, but also product information and advertisement information pre-stored on the server 1.

In step S103, after receiving the sets of promotional information through the initiating communication module 21, the initiating processing module 24 controls the initiating display module 23 to display the sets of promotional information for the initiating user to review and to select a set of basic promotional information from among the sets of promotional information.

In step S104, in response to another user input generated by the initiating input module 22 through operation by the initiating user (e.g., the initiating user operating the initiating input module 22 to select one of the sets of promotional information), the initiating processing module 24 obtains the set of basic promotional information from among the sets of promotional information, and transmits the set of basic promotional information to the server 1 through the initiating communication module 21.

In step S105, the server processing unit 13 transmits the user social dataset corresponding to the initiating user to the initiating device 2 through the server communication module 11. It is worth mentioning that in some embodiments, in addition to transmitting the user social dataset corresponding to the initiating user to the initiating device 2, the server processing unit 13 further transmits multiple recommended user accounts to the initiating device 2, where each recommended user account is one of the associated user accounts in the user social dataset corresponding to the initiating user. For each of the recommended user accounts, the associated user corresponding to the recommended user account may be, for example, but not limited to, a latest one of the associated users who has been added as a friend of the initiating user on one of the online platforms 3, or one of the associated users with whom the initiating user has been in contact with recently on one of the online platforms 3.

In step S106, after receiving through the initiating communication module 21 the user social dataset corresponding to the initiating user, the initiating processing module 24 controls the initiating display module 23 to display the user social dataset corresponding to the initiating user for the initiating user to review and to select at least one target user account from among the associated user accounts in the user social dataset corresponding to the initiating user, or for the initiating user to input multiple conditions used for filtering the associated user accounts to select at least one target user account. For example, the conditions may include, but are not limited to, age, gender and occupation. In the case that the server processing unit 13 further transmits the recommended user accounts to the initiating device 2, the initiating processing module 24 controls the initiating display module 23 to further display the recommended user accounts, such that the initiating user may select the at least one target user account with reference to the recommended user accounts.

In step 107, in response to another user input generated by the initiating input module 22 through operation by the initiating user (e.g., the initiating user operating the input module 22 to select the at least one target user account from among the associated user accounts, or to input the conditions used for filtering the associated user accounts to select at least one target user account), the initiating processing module 24 generates a recipient confirmation command, and transmits the recipient confirmation command to the server 1 through the initiating communication module 21. The recipient conformation command includes the at least one target user account selected by the initiating user or the conditions inputted by the initiating user.

In step S108, in response to receiving the recipient confirmation command from the initiating device 2 through the server communication module 11, the server processing module 13 obtains the at least one target user account based on the recipient confirmation command. When the recipient confirmation command includes the conditions inputted by the initiating user, the server processing module 13 automatically filters the associated user accounts to select the at least one target user account according to the conditions; and when the recipient command includes the at least one target user account selected by the initiating user, the server processing module 13 directly obtains the at least one target user account.

In step 109, the server processing module 13, based on the at least one target user account, obtains at least one of the online platforms 3 that corresponds respectively to the at least one target user account. Specifically, step S109 is to obtain, for each target user account, platform data that is related to one of the online platforms 3 which a user of the target user account is registered on, in based on the internet usage record of the target user account. It should be noted that, throughout this disclosure, the term “platform data” related to a platform may be, for example, an identification code corresponding to the platform, a uniform resource locator (URL) of the platform, other data that can be used to indicate the platform, or combinations thereof.

In step S110, the server processing module 13 obtains at least one recommended platform 3 from among the online platforms 3 based on the internet usage record of each target user account. Specifically, step S110 is to obtain, for each target user account, platform data related to the online platform(s) 3 frequently visited by the user of the target user account.

In step S111, the server processing module 13 makes the at least one of the online platforms 3 that corresponds respectively to the at least one target user account, and the at least one recommended platform 3 jointly serve as at least one candidate platform 3, and transmits platform data related to the at least one candidate platform 3 to the initiating device 2 through the server communication module 11. It is worth mentioning that in some embodiments, the server processing module 13 may also make the at least one of the online platforms 3 independently serve as the at least one candidate platform 3, or make the at least one recommended online platform 3 independently serve as the at least one candidate platform 3. That is, the at least one candidate platform 3 may include only the at least one of the online platforms 3, include only the at least one candidate platform 3, or include both of the at least one of the online platforms 3 and the at least one candidate platform 3.

In step S112, after receiving the platform data related to the at least one candidate platform 3 through the initiating communication module 21, the initiating processing module 24 controls the display module 23 to display the at least one candidate platform 3 for the initiating user to select at least one target platform 3 from among the at least one candidate platform 3.

In step S113, in response to another user input generated by the initiating input module 22 through operation by the initiating user (e.g., the initiating user operating the initiating input module 22 to select the at least one target platform 3 from among the at least one candidate platform 3), the initiating processing module 24 obtains the at least one target platform 3 from among the at least one candidate platform 3, and transmits platform data related to the at least one target platform 3 to the server 1 through the initiating communication module 21, wherein each target platform 3 is one of the at least one candidate platform 3.

It is worth mentioning that in some embodiments, the server processing module 13 may also, in step S109, make the at least one of the online platforms 3 that corresponds to the at least one target user account directly serve as the at least one target platform 3.

In one example shown in Table 1, the user social dataset corresponding to the initiating user includes three associated users lists corresponding respectively to three online platforms, i.e., List A corresponding to Platform 3A, List B corresponding to Platform 3B, and List C corresponding to Platform 3C. The associated user accounts included in List A includes Account A1, Account A2 and Account A3. The associated user accounts included in List B includes Account B1 and Account B2. The associated user accounts included in List C includes Account C1, Account C2 and Account C3. In steps S105 to S108, the initiating user selects Account A1 and Account C2 from among all of the associated user accounts mentioned above to serve as the target user accounts. Then, in steps S109 and S111, the server 1 obtains Platform 3A corresponding to List A which includes Account A1, and Platform 3C corresponding to List C which includes Account C2, and makes Platform 3A and Platform 3C jointly serve as the candidate platforms 3. Finally, in steps S112 and S113, the initiating user selects Platform 3C to serve as the target platform 3.

TABLE 1

| Associated | Corresponding | |
|---|---|---|
| Users List | Online Platform | Associated User Account(s) |
| List A | Platform 3A | Account A1, Account A2, Account A3 |
| List B | Platform 3B | Account B1, Account B2 |
| List C | Platform 3C | Account C1, Account C2, Account C3 |

In step S114, in response to another user input generated by the initiating input module 22 through operation by the initiating user (e.g., the initiating user operating the initiating input module 22 to input some information), the initiating processing module 24 generates a set of adjustment information for adjusting the set of basic promotional information, and transmits the set of adjustment information to the server 1 through the initiating communication module 21. It is worth mentioning that in this embodiment, the set of adjustment information may be natural language inputted by the initiating user, or a natural language copy generated by using an LLM, but is not limited thereto. For example, when the set of basic promotional information is a promotional video for iPhones, the set of adjustment information for adjusting the promotional video may be “Add the feeling of summer” or “Change to promoting iPhone's photography stabilization function” for regenerating another promotional video for iPhones; and when the set of basic promotional information is a promotional image for iPhones, the set of adjustment information for adjusting the promotional image may be “Please switch to a different copy” or “Change to promoting iPhone's benefits to intimate relationships” for regenerating another promotional image for iPhones, but the disclosure is not limited thereto.

In step S115, after receiving the set of adjustment information from the initiating device 2 through the server communication module 11, the server processing module 13, based on the set of basic promotional information, which was received in step S104, and the set of adjustment information, generates a set of target promotional information by utilizing an advertisement generation model, and transmits the set of target promotional information to the initiating device 2 through the server communication module 11.

It is worth mentioning that in this embodiment, the advertisement generation model includes an LLM (e.g., ChatGPT, etc.), an image generation model (e.g., DALL-E3, etc.), a music generation model (e.g., MusicGen, etc.), a speech generation model (e.g., Google Cloud Text to Speech, etc.), a video generation model (e.g., Sora, etc.), or combinations thereof. For example, when the advertisement generation model includes an image generation model and a music generation model, and the set of basic promotional information is an image, the server 1 can, based on the set of adjustment information, utilize the image generation model to generate a to-be-integrated image, and at the same time, based on the set of adjustment information, utilize the music generation model to generate a piece of to-be-integrated music; then, the server 1 can combine the to-be-integrated image and the piece of to-be-integrated music to serve as the set of target promotional information. As another example, when the advertisement generation model includes a video generation model, a speech general model and a music generation model, and the set of basic promotional information is a video, the server 1 can, based on the set of adjustment information, utilize the video generation model to generate a to-be-integrated video, utilize the speech generation model to generate a piece of to-be-integrated speech, and utilize the music generation model to generate a piece of to-be-integrated music; then, the server 1 can combine the to-be-integrated video, the piece of to-be-integrated speech, and the piece of to-be-integrated music to serve as the set of target promotional information. It should be noted that the disclosure is not limited to the foregoing examples.

In step S116, after receiving the set of target promotional information through the initiating communication module 21, the initiating processing module 24 controls the initiating display module 23 to display the set of target promotional information for the initiating user to review.

In step S117, in response to another user input generated by the initiating input module 22 through operation by the initiating user (e.g., the initiating user operating the input module 22 to input some information), the initiating processing module 24 generates a regenerate command that includes another set of adjustment information, or a publish command that instructs publishing of the set of target promotional information and that includes a payment amount (i.e., the initiating processing module 21 generates either a regenerate command or a publish command), and transmits the command thus generated to the server 1 through the initiating communication module 21. When the initiating device 2 generates and transmits to the server 1 the regenerate command, a flow of the method proceeds to step S118. When the initiating device 2 generates and transmits to the server 1 the publish command, the flow of the method proceeds to step S119. It is worth mentioning that in some embodiments, the payment amount may also be used to determine the number of times the set of target promotional information is to be published.

In step S118, in response to receiving the regenerate command from the initiating device 2 through the server communication module 11, the server processing module 13, based on the set of target promotional information and the another set of adjustment information, regenerates another set of target promotional information by utilizing the advertisement generation model, and transmits the regenerated set of target promotional information to the initiating device 2 through the server communication module 11. The flow of the method then proceeds to step S116 again for the initiating user to review and decide whether the regenerated set of target promotional information needs to be modified, and then to step S117 again for the initiating processing module 24 to generate either another regenerate command or the publish command, and transmit the same to the server 1. The content of the another regenerate command is similar to that of the regenerate command mentioned above, and thus will be omitted herein. Then, the flow of the method proceeds to step S118 when the another regenerate command is generated and transmitted to the server 1, and to step S119 when the publish command is generated and transmitted to the server 1. In other words, the flow of the method continues to cycle through steps S116, S117 and S118 until the publish command is generated and transmitted to the server 1, at which time the flow proceeds to step S119.

In step S119, in response to receiving the publish command from the initiating device 2 through the server communication module 11, the server processing module 13 generates a payment request based on the payment amount, and transmits the payment request to the initiating device 2 through the server communication module 11.

In step S120, after receiving the payment request through the initiating communication module 21, the initiating processing module 24, based on the payment request, generates a submit payment command that includes the payment amount, and transmits the submit payment command to the cash flow unit 6 through the initiating communication module 21.

In step S121, in response to receiving the submit payment command from the initiating device 2, the cash flow unit 6 transfers the payment amount from the initiating user money account to the server money account, and generates and transmit to the server 1 a payment submitted notification indicating receipt of the payment amount from the initiating user money account.

In step S122, after receiving the payment submitted notification from the cash flow unit 6 through the server communication module 11, the server processing module 13 utilizes an automatic review model to determine whether the set of target promotional information complies with publishing requirements. In response to the server processing module 13 determining that the set of target promotional information complies with the publishing requirements, the flow of the method proceeds to step S123. In response to the server processing module 13 determining that the set of target promotional information does not comply with the publishing requirements, the flow of the method terminates. It is worth mentioning that the automatic review model is a well-known automated review model, which is based on natural language processing, image recognition, audio recognition and other technologies, and is used to review whether there are any concerns about illegality or infringement of published content. In this embodiment, the review device 5 may be omitted.

It is also worth mentioning that in some embodiments, instead of utilizing the automatic review model, the server 1 may transmit the set of target promotional information to the review device 5. Specifically, after receiving the set of target promotional information through the review communication module 51, the review processing module 54 controls the review display module 53 to display the set of target promotional information for the reviewer to review and decide whether the set of target promotional information complies with the publishing requirements (i.e., whether the set of target promotional information has illegality or infringement of content). Then, in response to a user input generated by the review input module 52 through operation by the reviewer (e.g., the reviewer using the review input module 52 to input information on his/her decision regarding compliance of the set of target promotional information with the publishing requirements), the review processing module 54 generates either an approve publishing command or a stop publishing command, and transmits the command thus generated to the server 1 through the review communication module 51. When the review device 5 generates and transmits to the server 1 the approve publishing command, the flow of the method proceeds to step S123. When the review device 5 generates and transmits to the server 1 the stop publishing command, the flow of the method terminates.

In step S123, for each target platform 3, the server processing module 13 makes the at least one target user account corresponding to the target platform 3 serve as at least one promotion user account, and transmits to the target platform 3 through the server communication module 11 the set of target promotional information, a publishing account of one of the users who published the set of basic promotional information, and the at least one promotion user account. For example, if the set of basic promotional information is related to a short video produced by a blogger about iPhones, the publishing account is the blogger's account on the target platform 3, but the disclosure is not limited thereto.

In step S124, each target platform 3 publishes the set of target promotional information through the publishing account to transmit the set of target promotional information to at least one target promotion-end device 4 corresponding to the at least one promotion user account, where each of the at least one target promotion-end device 4 is one of the promotion-end devices 4 that belongs to a user who registers one of the at least one promotion user account on the target platform 3. It is worth mentioning that in some embodiments, the server processing module 13 also, based on the payment amount, generates and transmits to the target platform 3 a number of times the set of target promotional information is to be published for the target platform 3 to publish the set of target promotional information to the at least one target promotion-end device 4 based on the number of times.

In step S125, for each target promotion-end device 4, after receiving the set of target promotional information through the promotion-end communication module 41, the promotion-end processing module 44 controls the promotion-end display module 43 to display the set of target promotional information.

Specifically, for each promotion user account, when a promotion-end user of the promotion user account logs in to the target online platform 3 through their promotion-end device 4 using the promotion user account, the promotion-end user will be able to view the target promotional information published through the publishing account on a user interface of the promotion user account. At the same time, the target platform 3 will also record a number of times the target promotional information is viewed by the promotion user account.

In summary, through the system 100 for generating and sending an advertisement, the method of the disclosure automatically recommends the sets of promotional information related to the object based on natural language inputted by the initiating user for the initiating user to select the set of basic promotional information from among the sets of promotional information. Then, the initiating user selects the target platform 3 for publishing and the at least one promotion user account. Based on the set of basic promotional information and natural language further inputted by the initiating user, and by utilizing an advertisement generation model, the set of target promotional information continues to be adjusted. Finally, payment for publishing the set of target promotional information is submitted from the initiating user money account, and the set of target promotional information is published to the target platform 3 through the publishing account after it is determined through a review process that the set of promotional information complies with the publishing requirements, thereby transmitting the set of target promotional information to selected promotion-end user(s) of the target promotion-end device(s) 4. The disclosure provides the initiating user with a method that can not only generate an advertisement through the system 100 at a relatively low cost, but also publish the advertisement through the publishing account, which may increase promotion-end user acceptance of the advertisement. By virtue of the method of this disclosure, the advertisement can be transmitted to the promotion-end user(s) selected by the initiating user, improving effectiveness of the advertisement, and thereby achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for generating and sending an advertisement, to be implemented by a server that communicates with an initiating device operated by an initiating user and with at least one online platform, each one of the at least one online platform communicating with multiple promotion-end devices, the server storing multiple user social datasets that are related respectively to multiple users including the initiating user, each one of the user social datasets including at least one associated users list respectively corresponding to the at least one online platform, each one of the at least one associated users list including multiple associated user accounts of multiple associated users that are associated with a corresponding one of the users, the method comprising steps of:
based on a set of input information from the initiating device and related to an object, obtaining, by utilizing a promotional information recommendation model, multiple sets of promotional information that are related to the object, and transmitting the sets of promotional information to the initiating device for the initiating device to obtain a set of basic promotional information from among the sets of promotional information and to transmit the set of basic promotional information to the server;
in response to receipt of a recipient confirmation command from the initiating device, obtaining at least one target user account from among the associated user accounts in one of the user social datasets corresponding to the initiating user, and obtaining at least one target platform based on the at least one target user account;
based on the set of basic promotional information and a set of adjustment information used for adjusting the set of basic promotional information, generating a set of target promotional information by utilizing an advertisement generation model; and
for each target platform of the at least one target platform, making the at least one target user account corresponding to the target platform serve as at least one promotion user account, and transmitting the set of target promotional information and the at least one promotion user account to the target platform for the target platform to transmit the set of target promotional information to at least one target promotion-end device that corresponds to the at least one promotion user account, each one of the at least one target promotion-end device being one of the promotion-end devices.

2. The method as claimed in claim 1, wherein, in the step of transmitting the set of target promotional information and the at least one promotion user account to the at least one target platform,
the server further transmits to the at least one target platform a publishing account of one of the users who published the set of basic promotional information for the at least one target platform to publish the set of target promotional information through the publishing account to transmit the set of target promotional information to the at least one target promotion-end device.

3. The method as claimed in claim 1, further comprising steps of:
after generating the set of target promotional information, transmitting the set of target promotional information to the initiating device for the initiating device to generate and transmit to the server one of a regenerate command that includes another set of adjustment information, and a publish command that instructs publishing of the set of target promotional information; and
in response to receipt of the regenerate command from the initiating device, based on the set of target promotional information and the another set of adjustment information, regenerating the set of target promotional information by utilizing the advertisement generation model, and transmitting to the initiating device the set of target promotional information thus regenerated for the initiating device to generate and transmit to the server one of another regenerate command and the publish command,
wherein transmitting to the at least one target platform the set of target promotional information and the at least one promotion user account is implemented in response to receipt of the publish command from the initiating device.

4. The method as claimed in claim 3, the server further communicating with a cash flow unit that communicates with the initiating device and that stores an initiating user money account of the initiating user and a server money account of the server,
wherein the publish command further includes a payment amount, and the method further comprises:
in response to receipt of the publish command from the initiating device, generating a payment request based on the payment amount, and transmitting the payment request to the initiating device for the initiating device to generate, based on the payment request, a submit payment command that includes the payment amount, and to transmit the submit payment command to the cash flow unit, so that the cash flow unit transfers the payment amount from the initiating user money account to the server money account,
wherein, in the step of transmitting the set of target promotional information and the at least one promotion user account to the at least one target platform, the set of target promotional information and the at least one promotion user account are transmitted to the at least one target platform in response to receiving from the cash flow unit a payment submitted notification that indicates receipt of the payment amount from the initiating user money account.

5. The method as claimed in claim 3, further comprising:
after receiving the publish command from the initiating device, by utilizing an automatic review model, determining whether the set of target promotional information complies with publishing requirements; and
in response to determining that the set of target promotional information complies with the publishing requirements, implementing the step of transmitting the set of target promotional information and the at least one promotion user account to the at least one target platform.

6. The method as claimed in claim 1, wherein the step of obtaining the at least one target platform includes:
based on the at least one target user account, obtaining platform data related to at least one of the at least one online platform that corresponds to the at least one target user account;
making the at least one of the at least one online platform serve as at least one candidate platform; and
transmitting platform data related to the at least one candidate platform to the initiating device for the initiating device to obtain and transmit platform data related to the at least one target platform to the server, so that the server obtains the at least one target platform, each one of the at least one target platform being one of the at least one candidate platform.

7. The method as claimed in claim 6, each associated users list of the at least one associated users list further including internet usage records respectively corresponding to the associated user accounts included in the associated users list, wherein the step of obtaining the at least one target platform further includes:
based on the internet usage records respectively corresponding to the associated user accounts, obtaining platform data related to at least one recommended platform, each one of the at least one recommended platform being one of the at least one online platform; and
making the at least one of the at least one online platform corresponding to the at least one target user account, and the at least one recommended platform jointly serve as the at least one candidate platform; and
transmitting the platform data related to the at least one candidate platform to the initiating device for the initiating device to obtain and transmit the platform data related to the at least one target platform to the server.

8. The method as claimed in claim 1, wherein the promotional information recommendation model includes a large language model, and the advertisement generation model includes a large language model, an image generation model, a music generation model, a speech generation model, a video generation model, or combinations thereof.

9. A server for generating and sending an advertisement, comprising:
a server communication module configured to communicate with an initiating device operated by an initiating user, and with at least one online platform, each one of the at least one online platform communicating with multiple promotion-end devices;
a server storage module configured to store multiple user social datasets that are related respectively to multiple users including the initiating user, each one of the user social datasets including at least one associated users list respectively corresponding to the at least one online platform, each one of the at least one associated users list including multiple associated user accounts of multiple associates users that are associated with a corresponding one of the users; and
a server processing module configured to be electrically connected to said server communication module and to said server storage module, said server processing module being further configured to,
in response to receiving through said server communication module a set of input information from the initiating device and related to an object, obtain, by utilizing a promotional information recommendation model, multiple sets of promotional information that are related to the object, and transmit the sets of promotional information to the initiating device through said server communication module for the initiating device to obtain a set of basic promotional information from among the sets of promotional information and to transmit the set of basic promotional information to the server,
in response to receiving through said server communication module a recipient confirmation command from the initiating device, obtain at least one target user account from among the associated user accounts in one of the user social datasets corresponding to the initiating user, and obtain at least one target platform based on the at least one target user account,
based on the set of basic promotional information and a set of adjustment information used for adjusting the set of basic promotional information, generate a set of target promotional information by utilizing an advertisement generation model,
for each target platform of the at least one target platform, make the at least one target user account corresponding to the target platform serve as at least one promotion user account, and transmit through said server communication module the set of target promotional information and the at least one promotion user account to the target platform for the target platform to transmit the set of target promotional information to at least one target promotion-end device that corresponds to the at least one promotion user account, each one of the at least one target promotion-end device being one of the promotion-end devices.

10. The server as claimed in claim 9, wherein said server processing module is further configured to transmit to the at least one target platform through said server communication module, along with transmitting the set of target promotional information and the at least one promotion user account, a publishing account of one of the users who is publishing the set of basic promotional information for the at least one target platform to publish the set of target promotional information through the publishing account to transmit the set of target promotional information to the at least one target promotion-end device.

11. The server as claimed in claim 9, wherein said server processing module is further configure to:
after generating the set of target promotional information, transmit the set of target promotional information to the initiating device through said server communication module for the initiating device to generate and transmit to the server one of a regenerate command that includes another set of adjustment information, and a publish command that instructs publishing of the set of target promotional information; and
in response to receiving the regenerate command from the initiating device through said server communication module, based on the set of target promotional information and the another set of adjustment information, regenerate the set of target promotional information by utilizing the advertisement generation model, and transmit to the initiating device through said server communication module the set of target promotional information thus regenerated for the initiating device to generate and transmit to the server one of another regenerate command and the publish command,
wherein transmitting to the at least one target platform through said server communication module the set of target promotional information and the at least one promotion user account is performed in response to receiving the publish command from the initiating device through said server communication module.

12. The server as claimed in claim 11, wherein the server further communicates with a cash flow unit that communicates with the initiating device and that stores an initiating user money account of the initiating user and a server money account of the server, the publish command further includes a payment amount, and said server processing module is further configure to:
in response to receiving the publish command from the initiating device through said server communication module, generate a payment request based on the payment amount, and transmit the payment request to the initiating device through said server communication module for the initiating device to generate, based on the payment request, a submit payment command that includes the payment amount, and to transmit the submit payment command to the cash flow unit, so that the cash flow unit transfers the payment amount from the initiating user money account to the server money account,
wherein transmitting the set of target promotional information and the at least one promotion user account to the at least one target platform through said server communication module is performed in response to receiving from the cash flow unit, through said server communication module, a payment submitted notification that indicates receipt of the payment amount from the initiating user money account.

13. The server as claimed in claim 11, wherein said server processing module is further configured to:
after receiving the publish command from the initiating device through said server communication module, determine, by utilizing an automatic review model, whether the set of target promotional information complies with publishing requirements; and
in response to determining that the set of target promotional information complies with the publishing requirements, perform the transmitting of the set of target promotional information and the at least one promotional user account to the at least one target platform through said server communication module.

14. The server as claimed in claim 9, wherein said server processing module is configured to obtain the at least one target platform by:
based on the at least one target user account, obtaining platform data related to at least one of the at least one online platform that corresponds to the at least one target user account;
making the at least one of the at least one online platform serve as at least one candidate platform; and
transmitting platform data related to the at least one candidate platform to the initiating device through said server communication module for the initiating device to obtain and transmit platform data related to the at least one target platform to the server, so that the server obtains the at least one target platform, each one of the at least one target platform being one of the at least one candidate platform.

15. The server as claimed in claim 14, each associated users list of the at least one associated users list further including internet usage records respectively corresponding to the associated user accounts in the associated users list, wherein to obtain the at least one target platform, said server processing module is further configured to:
based on the internet usage records respectively corresponding to the associated user accounts, obtain platform data related to at least one recommended platform, each one of the at least one recommended platform being one of the at least one online platform;
make the at least one of the at least one online platform corresponding to the at least one target user account, and the at least one recommended platform jointly serve as the at least one candidate platform; and
transmit the platform data related to the at least one candidate platform to the initiating device through said server communication module for the initiating device to obtain and transmit the platform data related to the at least one target platform to the server.

16. The server as claimed in claim 9, wherein the promotional information recommendation model includes a large language model, and the advertisement generation model includes a large language model, an image generation model, a music generation model, a speech generation model, a video generation model, or combinations thereof.
